(19) United States
(12) Patent Application Publication
(10) Pub. No.: US 2024/0383926 A1
(43) Pub. Date: Nov. 21, 2024

(54) DIRECTIONALLY ASSEMBLED FLEXIBLE MOF HYDROGEL, AND PREPARATION METHOD AND PROTON CONDUCTION APPLICATION THEREOF

(71) Applicants: Zhejiang University of Technology., Hangzhou (CN); Eco-Environmental Science Research & Design Institute of Zhejiang Province., Hangzhou (CN)

(72) Inventors: Lei Qin, Hangzhou (CN); Xiaoyan Mao, Huzhou (CN); Yingyu Tan, Hangzhou (CN); Fei Huang, Hangzhou (CN); Liang Zhang, Yuncheng (CN); Yu Zhang, Hangzhou (CN); Xingwei Xiang, Huzhou (CN)

(21) Appl. No.: 18/654,004

(22) Filed: May 3, 2024

(30) Foreign Application Priority Data
May 15, 2023 (CN) 202310554989X

(51) Int. Cl. C07F 7/00; C07F 15/02; C07F 15/06

(52) U.S. Cl. CPC C07F 7/003; C07F 15/025; C07F 15/065

(57) ABSTRACT

Provided are a directionally assembled flexible MOF hydrogel, a preparation method and a proton conduction application thereof. The prepared method includes: mixing a transition metal salt and L-Glu to prepare a mixed aqueous solution; putting the mixed aqueous solution into a reaction kettle to react at a constant reaction temperature in a range from 80° C. to 200° C. for a reaction period of 1-5 hours, to thereby obtain a reacted aqueous solution; cooling the reacted aqueous solution to room temperature; and washing the reacted aqueous solution after the cooling with deionized water and absolute ethanol, to thereby obtain the directionally assembled flexible MOF hydrogel, L-Glu-M (M—Zr, Fe, or Co), for sealing and storing. The preparation method is simpler and easier to operate, and the directionally assembled flexible MOF hydrogel has great prospects in the field of proton conducting technologies.

### CROSS-REFERENCE TO RELATED APPLICATION

This application claims priority to a Chinese patent application No. CN 202310554989.X, filed to China National Intellectual Property Administration (CNIPA) on May 15, 2023, which is herein incorporated by reference in its entirety.

### TECHNICAL FIELD

The disclosure relates to the field of proton conducting technologies, particularly to a directionally assembled flexible metal-organic framework (MOF) hydrogel and a preparation method thereof.

### BACKGROUND

In recent years, due to the increasingly serious energy and environmental problems, proton conductive materials have attracted more and more attention in the field of energy conversion and storage. Solid acid, which is represented by a chemical formula MₐH_{b}(XO₄)_{c}, where M represents a monovalent or divalent cation, XO4 represents a tetrahedral oxoanion, and a, b and c are integers, is a good proton conductive material. Even though the solid acid can have a higher conductivity through phase structure transformation at a higher temperature, water solubility and thermal instability thereof limit its practical application.

Even through some research has arrived at a theory that an oxide-based proton conductor has good conductivity at a higher temperature, some scholars have come to an opposite conclusion by studying a same material. As such, this theory is flawed, and still in a research and exploration stage.

At present, metal-organic frameworks (MOFs) materials show excellent performance in the field of proton conducting technologies, which have attracted the attention of researchers. Ordered pores of the MOFs materials can provide an effective path for proton shuttle mechanism (also known as Grotthuss mechanism), and a proton conductivity of the MOFs materials can be effectively improved by embedding proton donors and proton acceptors. Further, after proton donors are grafted to the MOFs materials or proton acceptor functional groups are connected to the MOFs materials, proton jumping points can be increased to achieve efficient transfer, and thereby achieve a higher proton conductivity. In addition, the MOFs materials have the advantages of structural designability, easy pore adjustment, and easy functional modification. Therefore, the MOFs materials have great prospects in the field of proton conducting technologies. However, most of MOFs proton conductive materials have poor water stability and are highly dependent on a content of water molecules in their pores. The water molecules in the pores can escape at a higher temperature, which leads to a sharp decline in the proton conductivity, greatly limiting a practical application of the MOFs proton conductive materials.

Therefore, it is particularly important to design a high-conductivity material with good stability and good water retention performance at a higher temperature.

### SUMMARY

An objective of the disclosure is to provide a high-conductivity material applied to proton conduction and with good stability and good water retention performance at a higher temperature, and a preparation method thereof.

Technical solutions of the disclosure are as follows.

In an aspect, a preparation method of a directionally assembled flexible metal-organic framework (MOF) hydrogel is provided according to an embodiment of the disclosure, which includes: mixing a transition metal salt and L-Glutamic acid (L-Glu) to obtain a mixed aqueous solution; putting the mixed aqueous solution into a reaction kettle to act at a constant reaction temperature in a range from 80° C. to 200° C. for a reaction period of 1-5 hours, to thereby obtain a reacted aqueous solution after the reacting is completed; cooling the reacted aqueous solution to room temperature (for example, in a range from 18° C. to 26° C.); and washing the reacted aqueous solution after the cooling with deionized water and absolute ethanol, to thereby obtain the directionally assembled flexible MOF hydrogel for sealing and storing; where the transition metal salt is one selected from the group consisting of a zirconium salt, an iron salt, and a cobalt salt.

In an embodiment, the zirconium salt is zirconium sulfate, such as Zr(SO₄)₂·H₂O; the iron salt is ferric chloride, such as FeCl₃ or FeCl₃·6H₂O; and the cobalt salt is cobalt nitrate, such as Co(NO₃)₂ or CO(NO₃)_{2.6}H₂O.

In an embodiment, a molar ratio of the L-Glu to the transition metal salt is in a range from 1:2 to 3:1. In a specific embodiment, the molar ratio of the L-Glu to the transition metal salt is 1:2.

In an embodiment, a concentration of the transition metal salt in the mixed aqueous solution is in a range from 1 mole per liter (mol/L) to 6 mol/L. In a specific embodiment, the concentration of the transition metal salt in the mixed aqueous solution is 4 mol/L.

In an embodiment, the constant reaction temperature is 150° C., and the reaction period is 2 hours.

In another aspect, a directionally assembled flexible MOF hydrogel is provided according to an embodiment of the disclosure, which is prepared by any one of the above preparation methods.

The directionally assembled flexible MOF hydrogel disclosed by the disclosure has a higher conductivity under the condition of a higher humidity, and thus can be used as a proton conductive material.

The disclosure has at least the following advantages.

1. The L-Glu-M (M=zirconium (Zr), iron (Fe), or cobalt (Co)) material has a higher conductivity.

2. The preparation method for the L-Glu-M (M=Zr, Fe, or Co) material is simpler, easier to operate, and pollution-free.

### BRIEF DESCRIPTION OF DRAWINGS

FIG. 1 illustrates a schematic diagram showing conductivities of L-Glu-M materials obtained through embodiments 1, 6, and 7 under different temperature conditions.

FIG. 2 illustrates a schematic diagram showing conductivities of L-Glu-M materials obtained through embodiments 3-5 under different humidity conditions.

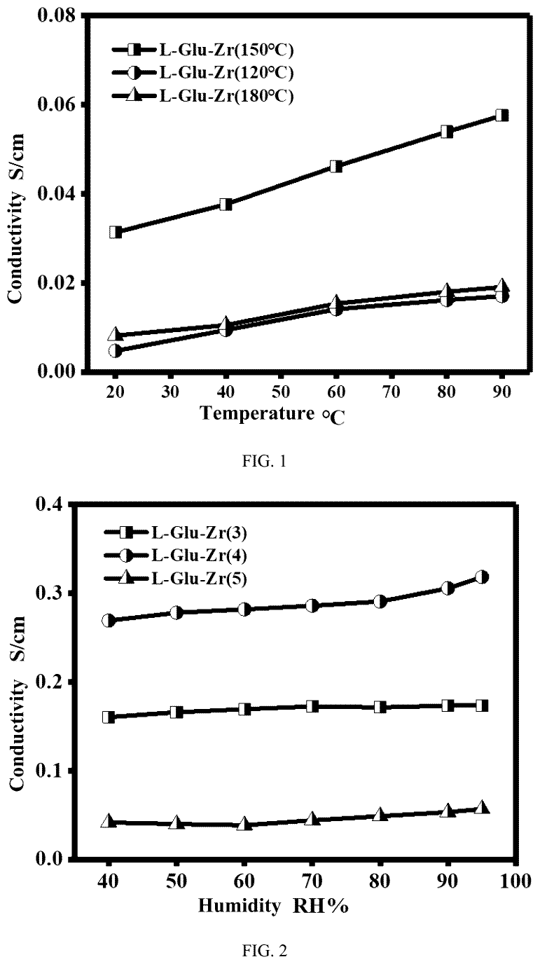

### DETAILED DESCRIPTION OF EMBODIMENTS

The disclosure will be further explained in detail in combined with embodiments and accompanying drawings hereinafter. It should be understood that the disclosure can be varied in different embodiments without departing from the scope of protection of the disclosure, and the description and the accompanying drawings herein are merely for illustration, but not for limitation of the disclosure.

### Embodiment 1

In the embodiment 1, L-Glu-Zr (1) is prepared through the following steps. A zirconium sulfate solution with a concentration of 1 mol/L is prepared. L-Glu is added into the zirconium sulfate solution and then stirred until clear to obtain a mixed aqueous solution, a molar ratio of zirconium sulfate in the zirconium sulfate solution to the L-Glu being 2:1. The mixed aqueous solution is put into a reaction kettle to react at a constant reaction temperature of 150° C. for a reaction period of 2 hours, to thereby obtain a reacted aqueous solution after the reacting is completed. The reacted aqueous solution is washed with deionized water and anhydrous ethanol for three times to thereby obtain the L-Glu-Zr (1), which is also referred to as L-Glu-Zr (150° C.).

### Embodiment 2

In the embodiment 2, L-Glu-Zr (2) is prepared through the following steps. A zirconium sulfate solution with a concentration of 2 mol/L is prepared. L-Glu is added into the zirconium sulfate solution and then stirred until clear to obtain a mixed aqueous solution, a molar ratio of zirconium sulfate in the zirconium sulfate solution to the L-Glu being 2:1. The mixed aqueous solution is put into a reaction kettle to react at a constant reaction temperature of 150° C. for a reaction period of 2 hours, to thereby obtain a reacted aqueous solution after the reacting is completed. The reacted aqueous solution is washed with deionized water and anhydrous ethanol for three times to thereby obtain the L-Glu-Zr (2).

### Embodiment 3

In the embodiment 3, L-Glu-Zr (3) is prepared through the following steps. A zirconium sulfate solution with a concentration of 3 mol/L is prepared. L-Glu is added into the zirconium sulfate solution and then stirred until clear to obtain mixed aqueous solution, a molar ratio of zirconium sulfate in the zirconium sulfate solution to the L-Glu being 2:1. The mixed aqueous solution is put into a reaction kettle to react at a constant reaction temperature of 150° C. for a reaction period of 2 hours, to thereby obtain a reacted aqueous solution after the reacting is completed. The reacted aqueous solution is washed with deionized water and anhydrous ethanol for three times to thereby obtain the L-Glu-Zr (3).

Embodiment 4

In the embodiment 4, L-Glu-Zr (4) is prepared through the following steps. A zirconium sulfate solution with a concentration of 4 mol/L is prepared. L-Glu is added into the zirconium sulfate solution and then stirred until clear to obtain mixed aqueous solution, a molar ratio of zirconium sulfate in the zirconium sulfate solution to the L-Glu being 2:1. The mixed aqueous solution is put into a reaction kettle to act at a constant reaction temperature of 150° C. for a reaction period of 2 hours, to thereby obtain a reacted aqueous solution after the reacting is completed. The reacted aqueous solution is washed with deionized water and anhydrous ethanol for three times to thereby obtain the L-Glu-Zr (4).

### Embodiment 5

In the embodiment 5, L-Glu-Zr (5) is prepared through the following steps. A zirconium sulfate solution with a concentration of 5 mol/L is prepared. L-Glu is added into the zirconium sulfate solution and then stirred until clear to obtain mixed aqueous solution, a molar ratio of zirconium sulfate in the zirconium sulfate solution to the L-Glu being 2:1. The mixed aqueous solution is put into a reaction kettle to react at a constant reaction temperature of 150° C. for a reaction period of 2 hours, to thereby obtain a reacted aqueous solution after the reacting is completed. The reacted aqueous solution is washed with deionized water and anhydrous ethanol for three times to thereby obtain the L-Glu-Zr (5).

### Embodiment 6

In the embodiment 6, L-Glu-Zr (120° C.) is prepared through the following steps. A zirconium sulfate solution with a concentration of 1 mol/L is prepared. L-Glu is added into the zirconium sulfate solution and then stirred until clear to obtain mixed aqueous solution, a molar ratio of zirconium sulfate in the zirconium sulfate solution to the L-Glu being 2:1. The mixed aqueous solution is put into a reaction kettle to act at a constant reaction temperature of 120° C. for a reaction period of 2 hours, to thereby obtain a reacted aqueous solution after the reacting is completed. The reacted aqueous solution is washed with deionized water and anhydrous ethanol for three times to thereby obtain the L-Glu-Zr (120° C.).

### Embodiment 7

In the embodiment 7, L-Glu-Zr (180° C.) is prepared through the following steps. A zirconium sulfate solution with a concentration of 1 mol/L is prepared. L-Glu is added into the zirconium sulfate solution and then stirred until clear to obtain mixed aqueous solution, a molar ratio of zirconium sulfate in the zirconium sulfate solution to the L-Glu being 2:1. The mixed aqueous solution is put into a reaction kettle to react at a constant reaction temperature of 180° C. for a reaction period of 2 hours, to thereby obtain a reacted aqueous solution after the reacting is completed. The reacted aqueous solution is washed with deionized water and anhydrous ethanol for three times to thereby obtain the L-Glu-Zr (180° C.).

### Embodiment 8

In the embodiment 8, L-Glu-Fe is prepared through the following steps. A ferric chloride solution with a concentration of 3 mol/L is prepared. L-Glu is added into the ferric chloride solution and then stirred until clear to obtain mixed aqueous solution, a molar ratio of zirconium sulfate in the zirconium sulfate solution to the L-Glu being 2:1. The mixed aqueous solution is put into a reaction kettle to react at a constant reaction temperature of 150° C. for a reaction period of 2 hours, to thereby obtain reacted aqueous solution after the reacting is completed. The reacted aqueous solution is washed with deionized water and anhydrous ethanol for three times to thereby obtain the L-Glu-Fe.

### Embodiment 9

In the embodiment 9, L-Glu-Co is obtained through the following steps. A cobalt nitrate solution with a concentration of 3 mol/L is prepared. L-Glu is added into the cobalt nitrate solution and then stirred until clear to obtain mixed aqueous solution, a molar ratio of zirconium sulfate in the zirconium sulfate solution to the L-Glu being 2:1. The mixed aqueous solution is put into a reaction kettle to react at a constant reaction temperature of 150° C. for a reaction period of 2 hours, to thereby obtain a reacted aqueous solution after the reacting is completed. The reacted aqueous solution is washed with deionized water and anhydrous ethanol for three times to thereby obtain the L-Glu-Co.

The obtained L-Glu-M (M=Zr, Fe or Co) materials in the embodiments 1-9 are made into cylinders with a radius of 1 centimeter (cm) and a height of 2 millimeters, and conductivities thereof are measured under different environment temperatures and environment humidities, as illustrated in Tables 1 and 2.

TABLE 1
Conductivities of L-Glu-M materials under different environment temperatures

| Environment | Conductivity (siemens per centimeter (S/cm) | | | | |
|---|---|---|---|---|---|
| temperature | Embodiment | Embodiment | Embodiment | Embodiment | Embodiment |
| (° C.) | 1 | 6 | 7 | 8 | 9 |
| 20 | 0.03132 | 0.00472 | 0.00815 | 0.00136 | 0.00086 |
| 40 | 0.03765 | 0.00942 | 0.01053 | 0.00245 | 0.00102 |
| 60 | 0.04619 | 0.01407 | 0.01535 | 0.00257 | 0.00235 |
| 80 | 0.05392 | 0.01614 | 0.01799 | 0.00281 | 0.00272 |
| 90 | 0.05757 | 0.01703 | 0.01907 | 0.00334 | 0.00311 |

TABLE 2
Conductivities of L-Glu-M materials under different
environment humidities

| Environment | | | |
|---|---|---|---|
| humidity | | | |
| (relative | Conductivity (S/cm) | | |
| humidity | Embodiment | Embodiment | Embodiment |
| (RH)%) | 3 | 4 | 5 |
| 40 | 0.16043 | 0.26921 | 0.04166 |
| 50 | 0.16579 | 0.27798 | 0.03988 |
| 60 | 0.16938 | 0.28178 | 0.03847 |
| 70 | 0.17246 | 0.28594 | 0.04404 |
| 80 | 0.71310 | 0.29069 | 0.04867 |
| 90 | 0.17327 | 0.30562 | 0.05329 |
| 95 | 0.17333 | 0.31831 | 0.05675 |

1. A preparation method of a directionally assembled flexible metal-organic framework (MOF) hydrogel, comprising:
mixing a transition metal salt and L-Glutamic acid (L-Glu) to prepare a mixed aqueous solution; putting the mixed aqueous solution into a reaction kettle to react at a constant reaction temperature in a range from 80° C. to 200° C. for a reaction period of 1-5 hours, to thereby obtain a reacted aqueous solution after the reacting is completed; cooling the reacted aqueous solution to room temperature; and washing the reacted aqueous solution after the cooling with deionized water and absolute ethanol, to thereby obtain the directionally assembled flexible MOF hydrogel for sealing and storing;
wherein a molar ratio of the L-Glu to the transition metal salt is 1:2, and the transition metal salt is one selected from the group consisting of a zirconium salt, an iron salt, and a cobalt salt.

2. The preparation method of the directionally assembled flexible MOF hydrogel as claimed in claim 1, wherein the zirconium salt is zirconium sulfate, the iron salt is ferric chloride, and the cobalt salt is cobalt nitrate.

3. The preparation method of the directionally assembled flexible MOF hydrogel as claimed in claim 1, wherein a concentration of the transition metal salt in the mixed aqueous solution is in a range from 1 mole per liter (mol/L) to 6 mol/L.

4. The preparation method of the directionally assembled flexible MOF hydrogel as claimed in claim 1, wherein the constant reaction temperature is 150° C., and the reaction period is 2 hours.

5-6. (canceled)
